(19) United States
(12) Patent Application Publication
(10) Pub. No.: US 2008/0282815 A1
(43) Pub. Date: Nov. 20, 2008

(54) Gas Sampler for Vapour Detectors

(76) Inventor: Jessal Murarji, Turbridge Wells (GB)

Correspondence Address: Mr Jessal Murarji, 119 Moira Street, Leicester, LE4 6LD, omitted

(21) Appl. No.: 12/122,346

(22) Filed: May 16, 2008

(30) Foreign Application Priority Data
May 18, 2007 (GB) GB0709578.9

(51) Int. Cl. G01N 1/22

(52) U.S. Cl. 73/863.71

(57) ABSTRACT

A gas sampling unit for vapour detectors, which incorporates a vortex 1 flowing towards the sampler/detector.

The vortex may be formed by the rotation of a cylinder 2 or cone about its axis. The cylinder or cone may be smooth, vaned or grooved inside. The vortex may also be produced by the channelling of a gas flow 4 by the wall of a cylinder or cone, or by vanes.

The vortex may be stabilised by the introduction of a liquid into the atmosphere outside the sampler. This liquid may also aid in the vaporisation or marking of the compounds to be detected.

The flow may be heated to aid in the formation and stabilisation of the vortex, and also in vaporisation of the compounds to be detected.

This invention relates to a device for sampling air and other gases, to be used in conjunction with vapour detectors.

Vapour detectors measure traces of characteristic volatile compounds that evaporate. Examples of their use are the detection of explosives, narcotics and chemical weapons.

The sampling method utilised by current vapour detectors, usually a pump, renders them with very little or no range, traces only being detected very close to the unit.

This makes the detectors useful in only controlled environments where it is possible to approach the target sample, or control the movement of the target sample.

In uncontrolled open-air environments, especially in the detection of suicide bombers and improvised explosive devices, they are not useful.

To overcome this problem, to increase the range and also to make the detectors uni-directional, the present invention proposes a sampling device, which in use creates a vortex in the ambient air.

The vortex will be forced to flow towards the sampler/detector, this will increase the detectable distance from the target sample. The separating nature of the vortex will also make the sampler uni-directional.

The separation of the vortex from the atmosphere will form an almost coherent mass, in the shape of a cylinder or cone, rotating like a solid body. Therefore the direction of the sample will be known to primarily originate from that cylinder or cone.

The invention will now be described by way of example, and with reference to the accompanying drawings in which:

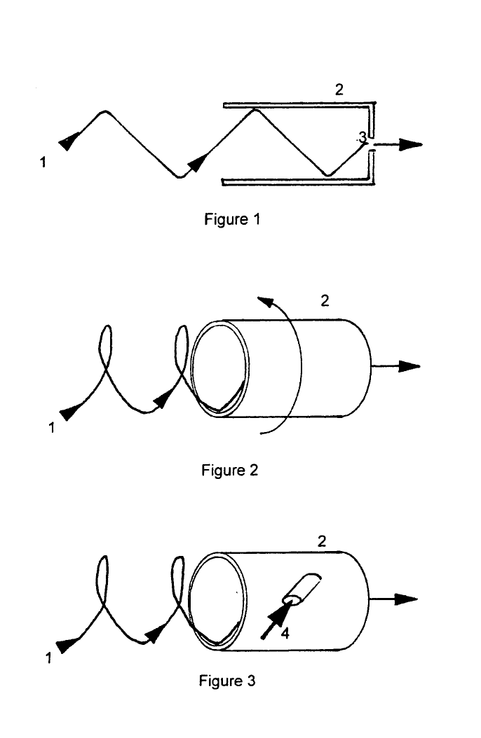

FIG. 1 shows the general principle of sampling by forming a vortex.

FIG. 2 shows an example of how the vortex may be formed by a rotating cylinder.

FIG. 3 shows an alternative example of how the vortex may be formed by the channelling of a gas flow.

The creation of the vortex 1 may be achieved by a cylinder 2 or cone rotating about its axis. This cylinder or cone will be at the front end of the sampler, the rotation will produce a vortex inside, and because the front of the cylinder or cone will be open, this vortex will extend outside the device into the ambient air, drawing in the sample of air or other gases towards the device. Refer to FIG. 2.

The cylinder or cone may be smooth, vaned or grooved inside.

The rear end of the cylinder or cone will have an orifice 3 to allow the gas to enter the vapour detector. Flow from the orifice at the rear end to the detector may be assisted by a pump or fan. Refer to FIG. 1.

The forcing of the vortex in the open air may also be achieved by the channelling of a gas flow 4 from a compressed supply, a volatile liquid or from a fan, into a cylinder or cone. This flow will hit the wall at an angle and continue to flow around the wall in a spiral route. Refer to FIG. 3. The channelling may also be performed by vanes.

A liquid may be introduced into the atmosphere outside the sampler, to stabilise the open-air vortex. A liquid may be chosen that could aid vaporisation of the compounds to be detected, and/or bind with them and act as a marker.

The flow may be heated to create temperature and pressure differences to aid in the formation and stabilisation of the vortex, and to aid vaporisation of the compounds to be detected.

The proposed invention may be incorporated into vapour detector designs, or be used to modify and improve vapour detectors already in use, by means of an attachment.

1. A gas sampling device for vapour detectors, which in use creates a vortex in the ambient air that flows towards the sampler/detector.

2. A gas sampling device according to claim 1, in which the vortex is produced in the ambient air by rotating about its axis, a cylinder or cone, smooth, vaned or grooved inside.

3. A gas sampling device according to claim 1, in which the vortex is produced in the ambient air by the channelling of a gas flow by the wall of a cylinder or cone, or by vanes.

4. A gas sampling device according to claim 1, in which a liquid is introduced into the atmosphere outside the sampler, to stabilise the vortex in the ambient air.

5. A gas sampling device according to claim 1, in which a liquid is introduced into the atmosphere outside the sampler, to aid vaporisation or act as a marker of the compounds to be detected.

6. A gas sampling device according to claim 1, which incorporates heat to aid formation and stabilisation of the vortex, and to aid vaporisation of the compounds to be detected.
